(19) United States
(12) Patent Application Publication
(10) Pub. No.: US 2009/0279702 A1
(43) Pub. Date: Nov. 12, 2009

(54) IMAGE PROCESSING APPARATUS AND CONTROL METHOD THEREOF

(75) Inventor: Junko Nemoto, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/463,866

(22) Filed: May 11, 2009

(30) Foreign Application Priority Data
May 12, 2008 (JP) 2008-124615

(51) Int. Cl. H04L 9/08; H04L 9/00

(52) U.S. Cl. 380/278; 380/44

(57) ABSTRACT

An image processing apparatus, to which a portable storage medium can be electrically connected, includes a generation unit configured to generate a pair of a public key and a private key, a medium detection unit configured to detect that the portable storage medium is connected to the image processing apparatus, a determination unit configured to determine whether the public key generated by the generation unit is stored in the portable storage medium detected by the medium detection unit, and a storage unit configured to store the public key generated by the generation unit in the portable storage medium based on the determination by the determination unit that the public key generated by the generation unit is not stored in the portable storage medium.

### BACKGROUND OF THE INVENTION

1. Field of the Invention

The present invention relates to an image processing apparatus capable of decrypting data encrypted with a public key by using a secret key and a control method for the image processing apparatus.

2. Description of the Related Background Art

Recently, as portable storage media, for example, universal serial bus (USB) memory, have grown in capacity and reduced in price, portable storage media have been used more in offices. Further, multifunction peripherals capable of directly receiving portable storage media, storing image data in portable storage media, and printing documents stored in the portable storage media have been widely spread. With such a function of multifunction peripherals, image data generated by scanning a paper document with a scanner can be stored in a portable storage medium to carry the image data. Still further, the data stored in the portable storage medium can be printed out by using a multifunction peripheral where a person is to use the data outside the office.

On the other hand, use of portable storage media enables data to be carried easily, however, which may cause leakage of information. Further, documents stored in portable storage media can be copied easily since the documents are stored in the form of electronic document, so that illegal copies, illegal use and alteration, and the like, have become a problem.

In view of the above, when image data or the like is stored in a portable storage medium in an image processing apparatus such as a multifunction peripheral, such a method is used that data to be stored is encrypted to improve confidentiality of the data.

As for a technique to encrypt data, there is a secret key encryption method (shared key encryption method) such as the International Data Encryption Algorithm (IDEA) method. Further, there is a public key encryption method such as the Rivest-Shamir-Adelman (RSA) method. The secret key encryption method uses a shared secret key for encryption and decryption. The public key encryption method uses a pair of different keys, i.e., a “public key” open to persons concerned and a “private key” secret to persons concerned. The document encrypted by the public key can be decrypted only with the private key, and the document encrypted by the private key can be decrypted only with the public key. By using the public key encryption method, a method of storing data in a portable storage medium in a multifunction peripheral is discussed in, for example, Japanese Patent Application Laid-open No. 2002-091744.

Further, a technique to prevent illegal copies and illegal use and alteration of image file data stored in a memory card, while making management of keys easy, is discussed. For example, such a key management method that collectively manages encryption keys on a server, namely, a method that the keys can be central controlled without being aware of the keys and the decryption processing by many users and administrators, is discussed in, for example, Japanese Patent No. 3592544.

Still further, such a method is discussed in, for example, Japanese Patent No. 3684179, that encryption key information is stored in a protection area of a portable storage medium, and that data other than data with an electronic signature contained in the information stored in the portable storage medium cannot be written in the portable storage medium.

In order to store encrypted data generated according to the public key encryption method in a portable storage medium, it is necessary to acquire a public key corresponding to a private key used for generating the encrypted data.

If there is no such server to which a multifunction peripheral capable of storing data in the portable storage medium as well as printing data is connectable and which is manageable, it is very difficult to acquire a public key.

### SUMMARY OF THE INVENTION

The present invention is directed to an image processing apparatus capable of acquiring a public key easily even from a multifunction peripheral, from which acquirement of a public key for encrypting a document is difficult, a control method thereof, and a program to be used therewith.

According to an aspect of the present invention, an image processing apparatus, to which a portable storage medium can be electrically connected, includes a generation unit configured to generate a pair of a public key and a private key, a medium detection unit configured to detect that the portable storage medium is connected to the image processing apparatus, a determination unit configured to determine whether the public key generated by the generation unit is stored in the portable storage medium detected by the medium detection unit, and a storage unit configured to store the public key generated by the generation unit in the portable storage medium if the determination unit determines that the public key generated by the generation unit is not stored in the portable storage medium.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating an exemplary configuration of a multifunction peripheral as an image processing apparatus according to a first exemplary embodiment of the present invention.

FIG. 2 is a flow chart illustrating an example of a process for storing a device information file in a portable storage medium in the multifunction peripheral.

FIG. 3 illustrates an exemplary configuration of the device information file.

FIG. 4 illustrates an example display of a confirmation screen for storing the device information file.

FIG. 5 is a flow chart illustrating an example of a process for registering device information and a public key in the multifunction peripheral.

FIG. 6 illustrates an exemplary configuration of a device information list screen.

FIG. 7 illustrates an example display of a screen notifying completion of a public key registration.

FIG. 8 illustrates an exemplary configuration of a key management table.

FIG. 9 is a flow chart illustrating an example of a process for storing encrypted data in the portable storage medium in the multifunction peripheral.

FIG. 10 illustrates an example display of a screen for selecting stored document that is displayed on an operation unit of the multifunction peripheral.

FIG. 11 illustrates an exemplary configuration of an address management table.

FIG. 12 is a flow chart illustrating an example of a process for storing encrypted data in the portable storage medium in the multifunction peripheral as an image processing apparatus according to a second exemplary embodiment of the present invention.

### DETAILED DESCRIPTION OF THE EMBODIMENTS

Various exemplary embodiments, features, and aspects of the invention will be described in detail below with reference to the drawings.

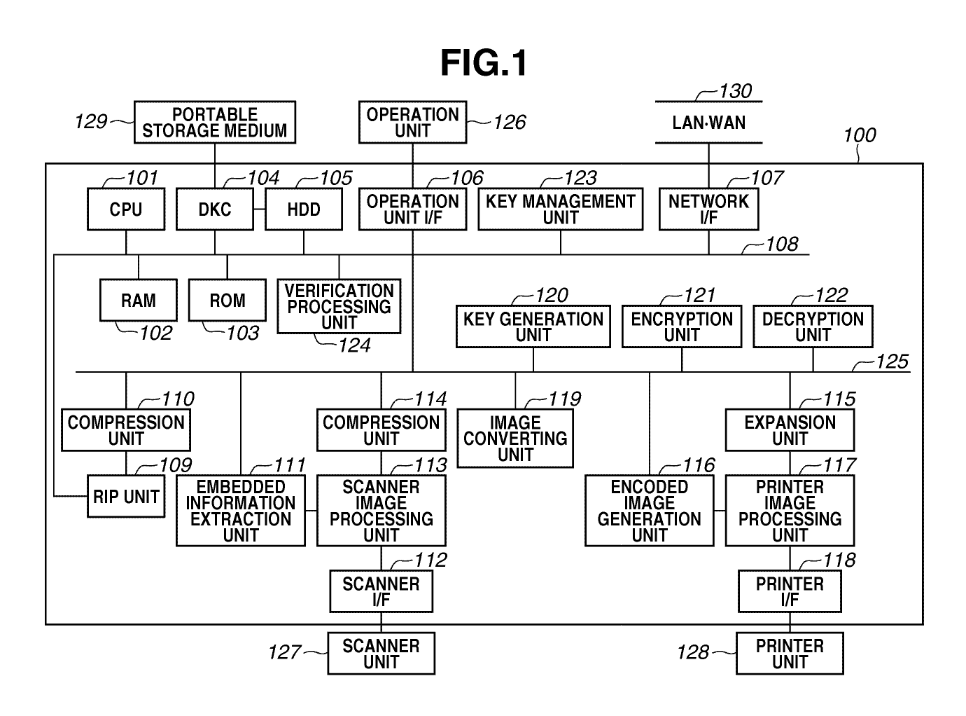

FIG. 1 is a block diagram illustrating an exemplary configuration of a multifunction peripheral as an image processing apparatus according to a first exemplary embodiment of the present invention.

In FIG. 1, the multifunction peripheral, including a controller 100, an operation unit 126, a scanner unit 127, and a printer unit 128, is configured to receive a portable storage medium 129. The controller 100 includes a central processing unit (CPU) 101, a random access memory (RAM) 102, a read only memory (ROM) 103, a disk controller (DKC) 104, a hard disk drive (HDD) 105, a key generation unit 120, an encryption unit 121, a decryption unit 122, a key management unit 123, an authentication processing unit 124, and others. The multifunction peripheral has functions to manage, by the key management unit 123, a paired public key/private key generated by the key generation unit 120, and to decrypt encrypted data encrypted with the public key by the decryption unit 122 by using the private key which corresponds to the public key.

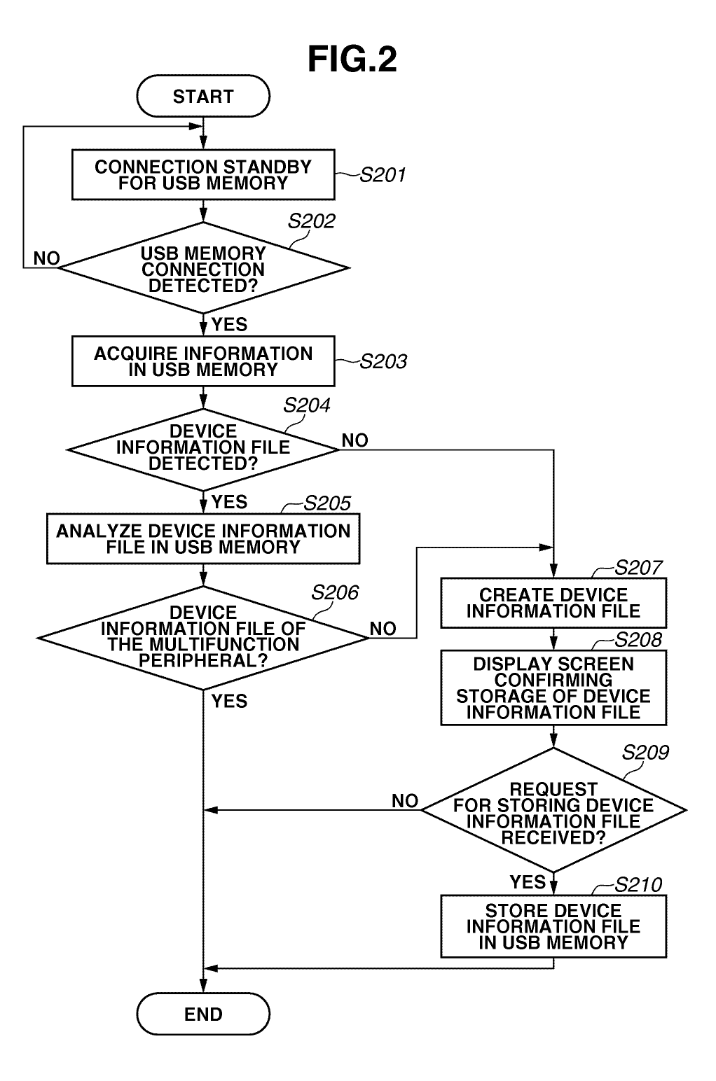

The CPU 101 collectively controls access between a system bus 108 and components that are connected to the system bus 108, based on a control program stored in the ROM 103 or the HDD 105. Further, the CPU 101 collectively controls each processing performed in the controller 100. Still further, the CPU 101 executes every processing of the flow charts illustrated in FIGS. 2, 5, 9, and 12, based on the control program.

The RAM 102 is used as a system work memory for operating the CPU 101 and as a memory for temporarily storing image data. The ROM 103 stores a boot program, a control program, and the like. The HDD 105 of which access is controlled by the DKC 104 can store system software, a control program, and image data. In the present exemplary embodiment, a key list and an address book management table, which will be described later, are stored in a memory device of either one of the RAM 102, the ROM 103, or the HDD 105.

The portable storage medium 129 is a detachable storage medium, e.g., a USB memory, a memory media card, of which access is controlled by the DKC 104, and can store image data and documents. The portable storage medium 129 can be electrically connected to a storage medium mounting unit (not illustrated) of the multifunction peripheral. In the present exemplary embodiment, a USB memory is exemplified as the portable storage medium 129.

An operation unit interface (I/F) 106 establishes connection between the system bus 108 and the operation unit 126. The operation unit I/F 106 receives image data to be displayed on the operation unit 126 via the system bus 108 and outputs the image data to the operation unit 126. Further, the operation unit I/F 106 outputs information input by an operator through the operation unit 126 to the system bus 108. A network I/F 107 establishes connection between the system bus 108 and a local area network (LAN)/wide area network (WAN) 130, and allows interactive transmission of data with an external device connected to the LAN/WAN 130. An image bus 125 is a peripheral component interconnect (PCI) compliant bus or an Institute of Electrical and Electronics Engineers (IEEE) 1394 standard compliant bus, i.e., is a transmission path that transmits image data.

A scanner image processing unit 113 performs correction, processing, and editing for image data read from a document received from a scanner unit 127 via a scanner I/F 112. An embedded information extraction unit 111 detects a pattern embedded in a background image and extracts additional information from the image data. A compression unit 114 receives image data from the scanner image processing unit 113 and compresses the image data. An expansion unit 115 expands and thereafter rasterizes the image data to send the image data to a printer image processing unit 117.

The printer image processing unit 117 receives the image data sent from the expansion unit 115 and performs image processing to the image data with reference to attribute data attached to the image data. Further, the printer image processing unit 117 combines the image data with encoded image data generated by the encoded image generation unit 116 when receiving the instruction. The encoded image generation unit 116 generates encoded image data, such as two-dimensional code image data, bar-code image data, and image data generated according to an information embedding technique.

To generate the encoded image data, information read from a memory card (not illustrated) by the CPU 101 or information input from the operation unit 126 is used. Generation of the encoded image data is performed by the encoded image generation unit 116 executing a program stored in the RAM 102. The processed image data is output to the printer unit 128 via the printer I/F 118 and printed by the printer unit 128.

An image converting unit 119 performs predetermined conversion processing, such as rotation, color space conversion, binary-to-multivalued conversion, image combining, and subsampling for the image data. A raster image processor (RIP) unit 109 receives intermediate data generated based on page description language (PDL) data to generate bit map data. The compression unit 110 compresses thus generated bit map data to send the data to the image bus 125.

The authentication processing unit 124 performs authentication to a print job input to the multifunction peripheral in addition to authentication of a user or a work group made by using user information input from the operation unit 126. The key generation unit 120 executes a key generating algorithm, thereby generating the paired public key/private key. The public key is used when data is encrypted to generate encrypted data. The private key is used when original data is restored based on the encrypted data generated by using the public key.

The encryption unit 121 encrypts a document by using an encryption key designated by the operation unit 126 or an encryption key designated by a program stored in the RAM 102 to generate encrypted data. The decryption unit 122 decrypts the encrypted data, which is encrypted by using the public key generated by the key generation unit 120, using the private key corresponding to the public key, thereby restoring the original data. The key management unit 123 stores and manages a public key and an encryption key generated by the key generation unit 120, and a plurality of public keys acquired from the portable storage medium 129 or external devices connected via the LAN/WAN 130.

Now, each processing of the multifunction peripheral of the present exemplary embodiment having the above-described configuration will be described below in detail with reference to FIGS. 2 through 11.

FIG. 2 is a flow chart illustrating an example of a process for storing a device information file in the portable storage medium 129 (e.g., USB memory) in the multifunction peripheral.

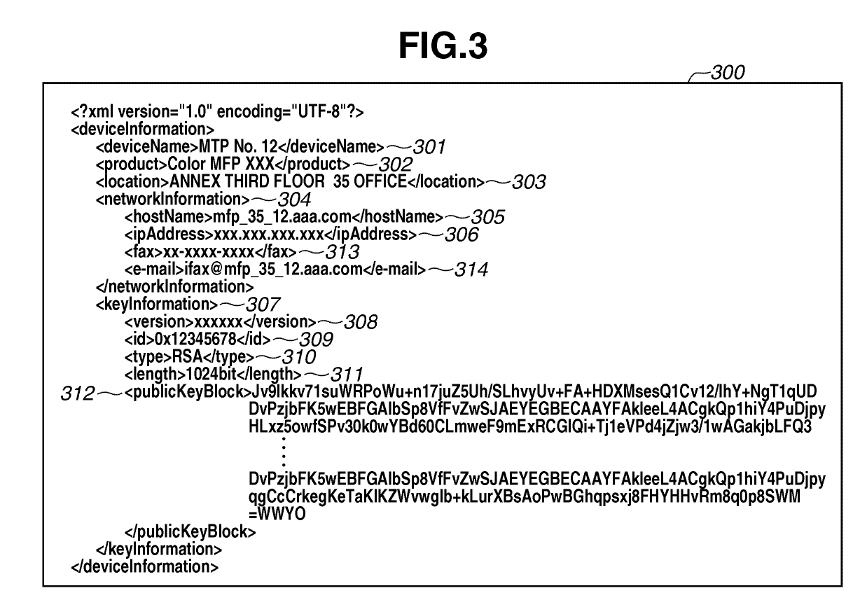

In FIG. 2, in step S201, the CPU 101 of the multifunction peripheral stands by until the USB memory is connected to a storage medium mounting unit of the multifunction peripheral. If the CPU 101 detects connection of the USB memory in step S202 (YES in step S202), in step S203, the CPU 101 acquires information from the USB memory. The information that the CPU 101 acquires from the USB memory includes, for example, the title or attribute information of a document stored in the USB memory. In step S204, the CPU 101 determines whether a device information file 300 illustrated in FIG. 3 is stored in the USB memory based on the information acquired in step S203.

The device information file 300 includes items of a device name 301, a product name 302, location information 303, network information 304, public key information 307, or the like. The network information 304 includes a facsimile (fax) number 313, an electronic mail (e-mail) address 314, and the like, in addition to a host name 305 and an Internet Protocol (IP) address 306. Further, the public key information 307 includes version information 309, identification (ID) information 310, type information 311, length information 312, and the like, in addition to public key block information 312.

Instep S204, if the CPU 101 determines that the device information file 300 is not stored in the USB memory (NO in step S204), the processing proceeds to step S207. On the other hand, in step S204, if the CPU 101 detects that the device information file 300 is stored in the USB memory (YES in step S204), then in step S205, the CPU 101 analyzes the device information file in the USB memory. In step S206, the CPU 101 determines whether the device information file of the multifunction peripheral has already been stored in the USB memory based on the analysis result in step S205.

Instep S206, if the CPU 101 determines that the device information file of the multifunction peripheral has already been stored in the USB memory (YES in step S206), the processing ends. On the other hand, in step S206, if the CPU 101 determines that the device information file of the multifunction peripheral is not stored in the USB memory (NO in step S206), the processing proceeds to step S207. In step S207, the CPU 101 generates a device information file (not illustrated) with respect to the multifunction peripheral since the CPU 101 has determined in step S204 or step S206 that the device information file 300 is not stored (saved).

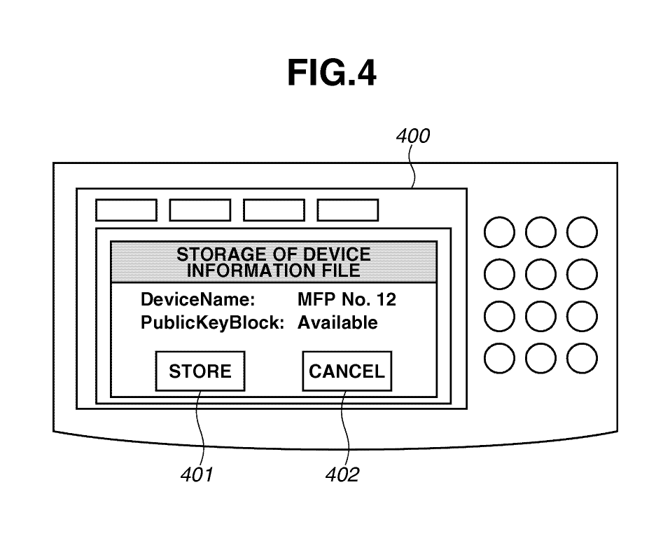

In step S208, the CPU 101 displays a confirmation screen 400 illustrated in FIG. 4 on the operation unit 126 in order to allow the operator to confirm whether the generated device information file is to be stored in the USB memory. In step S209, the CPU 101 determines whether an operator clicked a store button 401 of the confirmation screen 400.

In step S210, the CPU 101 stores the device information file in the USB memory if the CPU 101 detects that the operator clicked the store button 401 of the confirmation screen 400 in step S209 (YES in step S209). On the other hand, the processing ends, if the CPU 101 detects that the operator clicked a cancel button 402 of the confirmation screen 400 in step S209 (NO in step S209).

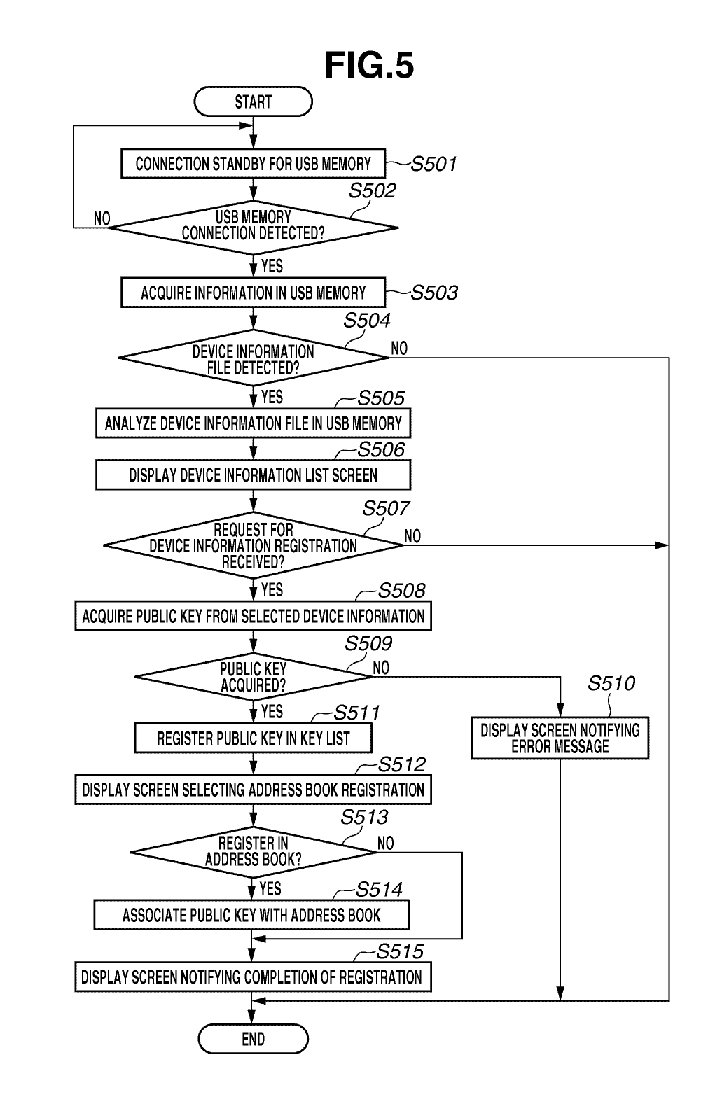

FIG. 5 is a flow chart illustrating an example of a process for registering device information and a public key in the multifunction peripheral.

In FIG. 5, descriptions of steps S501 through S504 are omitted since they are similar to the steps S201 through S204 of FIG. 2, respectively. The present processing ends if the CPU 101 determines in step S504 that the device information file 300 is not stored in the USB memory (NO in step S504). On the other hand, in step S505, the CPU 101 analyzes the device information file in the USB memory if the CPU 101 detects that the device information file 300 is stored in the USB memory (YES in step S504).

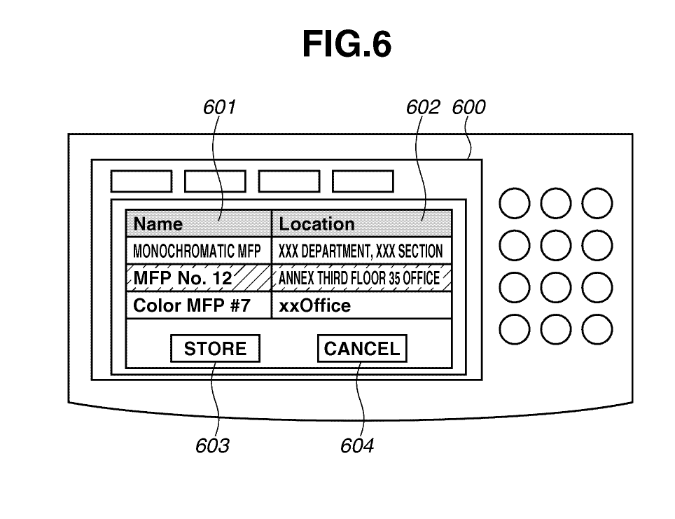

In step S506, the CPU 101 displays a device information list screen 600 illustrated in FIG. 6 on the operation unit 126 based on the result of the analysis in step S505. Information identifying the device (multifunction peripheral in the present embodiment), such as a device name 601 and location information 602 acquired from the device information file, is displayed in the device information list screen 600. In step S507, the CPU 101 then determines whether the operator clicked a store button 603 of the device information list screen 600 (i.e., whether the CPU 101 received a request for registration of the device information).

The processing proceeds to step S508 if the CPU 101 detects that the operator has selected a device (monochromatic multifunction peripheral (MFP), color MFP, or the like) listed in the device information list screen 600 and clicked the store button 603 in step S507 (YES in step S507). On the other hand, the CPU 101 ends the present processing if the CPU 101 detects that the operator clicked a cancel button 604 of the device information list screen 600 in step S507 (NO in step S507).

In step S508, the CPU 101 acquires a public key from the device information file corresponding to the device information the operator that is selected from the device information list screen 600 when the CPU 101 receives the request for registration of the device information in step S507. In step S509, the CPU 101 then determines whether the public key is successfully acquired.

If the CPU 101 determines that acquirement of the public key was unsuccessful in step S509 (NO in step S509), in step S510, the CPU 101 displays an error message notification screen (not illustrated), which notifies the operator of failure of acquirement of the public key, on the operation unit 126 to end the present processing. If the CPU 101 determines that the acquirement of the public key is successful (YES in step S509), then in step S511, the CPU 101 registers the public key in the key list by a key management unit 123.

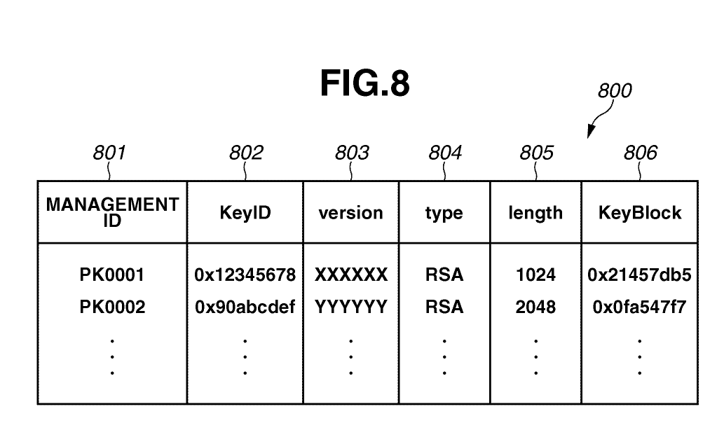

The key management unit 123 has a key management table 800 corresponding to the above-described key list, illustrated in FIG. 8. The key management table 800 includes items of a management identification (ID) 801, a key ID 802, version 803, type 804, length 805, and a key block 806. The management ID 801 is issued by the multifunction peripheral when the key is registered and thus, is a unique identifier in the multifunction peripheral.

In step S512, the CPU 101 displays an address book registration selection screen (not illustrated) on the operation unit 126. In the address book registration selection screen, it is possible to select whether the public key registered in the key list in step S511 is to be registered in association with address book information. In step S513, the CPU 101 determines whether the registration to the address book is selected.

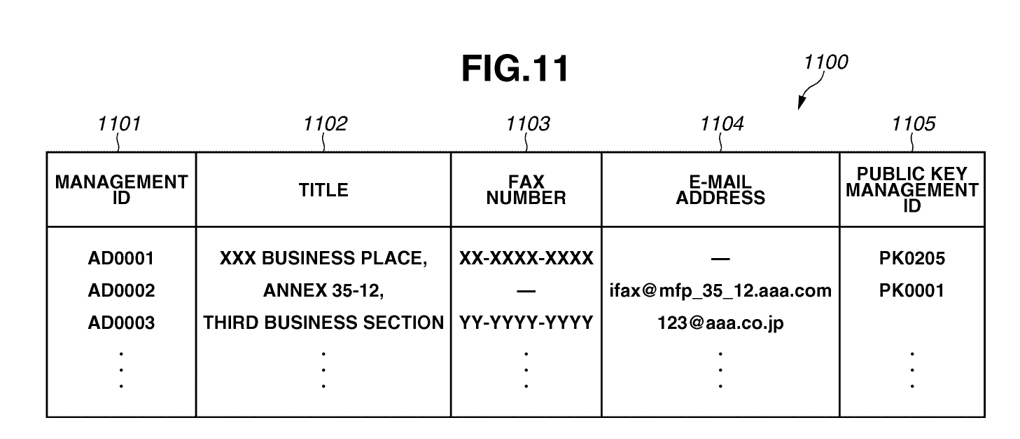

If the CPU 101 determines that the registration to the address book is selected in step S513 (YES in step S513), then in step S514, the CPU 101 performs the next registration based on the analysis result of the device information file acquired in step S505. The CPU 101 registers, in an address book management table 1100 illustrated in FIG. 11, device information such as a name, a fax number, and an e-mail address of the multifunction peripheral, and the management ID issued by the key management unit 123 when the public key is registered in the key list in step S511.

The address book management table 1100 includes a management ID 1101, a title 1102, a fax number 1103, an e-mail address 1104, and a public key management ID 1105 which identifies the public key in the key management table 800. The address book management table 1100 may manage address information other than the address information such as the fax number and the e-mail address.

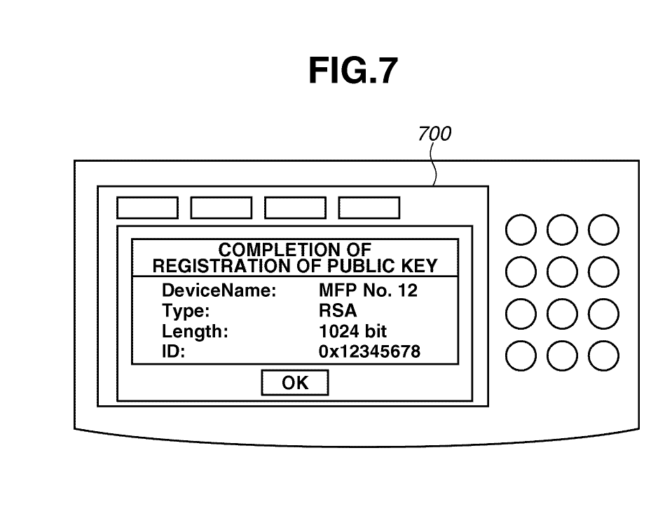

On the other hand, if the CPU determines that the registration to the address book was not selected in step S513 (NO in step S513), the processing proceeds to step S515. In step S515, the CPU 101 displays a registration completion notifying screen 700 illustrated in FIG. 7 on the operation unit 126, and then ends the present processing.

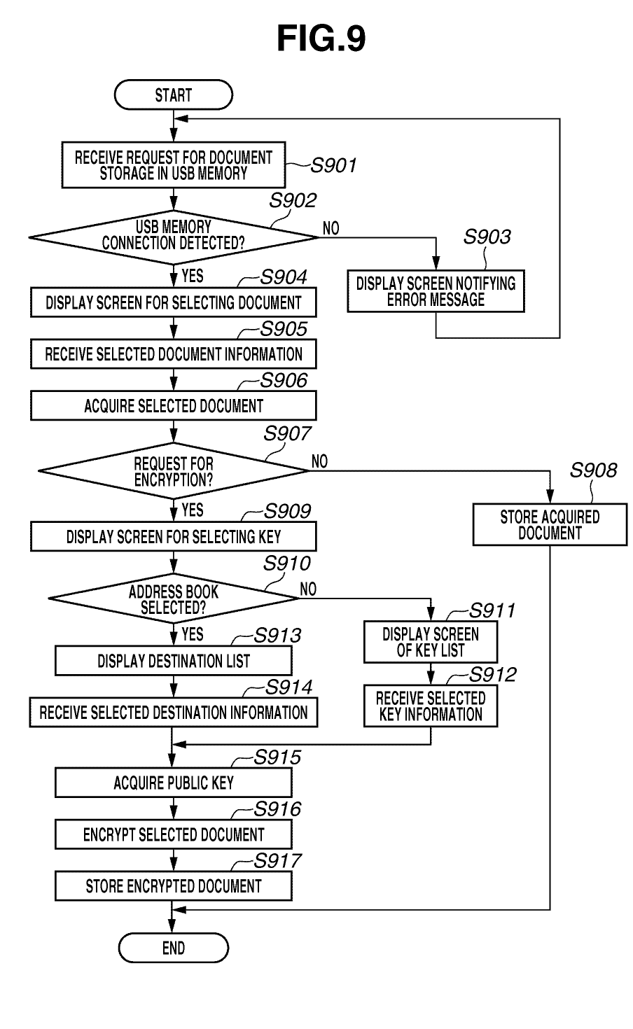

FIG. 9 is a flow chart illustrating an example of a process for storing encrypted data in the portable storage medium 129 (USB memory) in the multifunction peripheral.

When, in step S901, the CPU 101 of the multifunction peripheral receives from the operator a request for storing a document in the USB memory via the operation unit 126, then in step S902, the CPU 101 determines whether the USB memory is connected to a storage medium mounting unit of the multifunction peripheral.

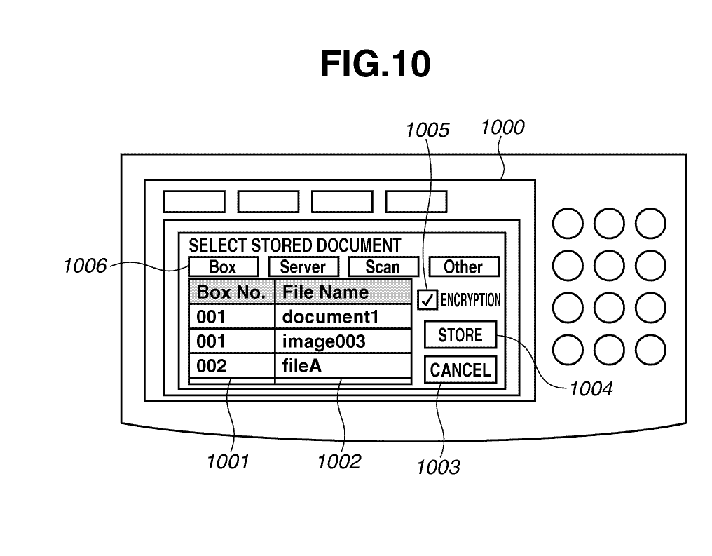

If the CPU 101 determines that the USB memory is not connected (NO in step S902), in step S903, the CPU 101 displays an error message notifying screen (not illustrated) which notifies the operator of disconnection of the USB memory and requests the operator to connect the USB memory. On the other hand, if the CPU 101 detects connection of the USB memory in step S902 (YES in step S902), then in step S904, the CPU 101 displays a stored document selecting screen 1000 illustrated in FIG. 10 on the operation unit 126.

The stored document selecting screen 1000 includes a list of documents preliminary stored in the HDD 105 of the multifunction peripheral. The stored document selecting screen 1000 displays a storing location selecting button 1006 for selecting a storing location for the document to be stored, a document list including a document title 1002 or the like corresponding to the selected storing location, a cancel button 1003, a store button 1004, and the like. Further, if an encryption check box 1005 is checked in the stored document selecting screen 1000, the selected document can be encrypted by the encryption unit 121 and thus can be stored in the USB memory.

In step S905, the CPU 101 then receives document information selected in the stored document selecting screen 1000 and information relating to necessity for encryption. In step S906, the CPU 101 acquires the selected document based on the document information received in step S905. In step S907, the CPU 101 determines whether the selected document is required to be encrypted based on the information received in step S905.

If the CPU 101 determines that there is no encryption request (NO in step S907), in step S908, the CPU 101 stores the document acquired in step S906 in the USB memory to end the present processing. On the other hand, if the CPU 101 determines that there is an encryption request in step S907 (YES in step S907), then in step S909, the CPU 101 displays a key selecting screen (not illustrated) on the operation unit 126. On the key selecting screen, selection can be made whether the public key to be used for encryption is designated from the address book or designated from the key list.

In step S910, the CPU 101 determines whether the address book or the key list is selected as the destination of the public key to be used for encryption. If the CPU 101 determines that the key list is selected (NO in step S910), then in step S911, the CPU 101 displays a key list screen (not illustrated) on the operation unit 126. In step S912, the CPU 101 receives the key information selected by the operator on the key list screen. On the other hand, if the CPU 101 determines that the address book is selected in step S910 (YES in step S910), then in step S913, the CPU 101 displays a destination list screen (not illustrated) on the operation unit 126. In step S914, the CPU 101 receives the destination information selected by the operator in the destination list screen.

In step S915, the CPU 101 acquires the public key identified by the key management ID contained in the received key information or the received destination information from the key management unit 123. In step S916, the CPU 101 causes the encryption unit 121 to encrypt the document acquired in step S906 by using the public key acquired in step S915 to generate an encrypted document. In step S917, the CPU 101 stores the encrypted document generated in step S916 in the USB memory and ends the present processing.

In step S916, the selected document may be subjected to a common key encryption by using a predetermined common key to thereafter encrypt the common key by using the public key, without directly encrypting the selected document by using the public key. In this case, in step S917, the encrypted document and the encrypted common key are stored in the USB memory. The predetermined common key may be generated based on random numbers generated by the multifunction peripheral.

In the present exemplary embodiment, the public key composed of the paired public key/private key generated by the key generation unit 120 of the multifunction peripheral can be stored in the portable storage medium (USB memory) without the user's request. Accordingly, the public key can be distributed with ease.

Further, when storing the public key in the portable storage medium, the public key can be registered in another multifunction peripheral easily by storing the device information file in the portable storage medium.

Further, by registering the public key information in the address book in association therewith, an encrypted document, which can be decrypted only by the predetermined multifunction peripheral, can be generated by the user only selecting the output destination or transmitting destination of the data while the user is unaware of the public key.

According to the above-described exemplary embodiment, the public key can be acquired easily from the multifunction peripheral from which it is difficult to acquire the public key for encrypting documents, i.e., from the multifunction peripheral incapable of being connected to a network.

Further, by using the key acquired when the data is stored in the portable storage medium, it becomes possible to generate an encrypted document capable of being decrypted only when a document is printed out by a specific multifunction peripheral. As a result, security is kept for the encrypted document since the encrypted document cannot be decrypted or printed out by an unexpected multifunction peripheral or personal computer.

Further, by registering the public key stored in the portable storage medium in the address book in the multifunction peripheral, the user can encrypt a document with a appropriate public key by only designating the destination, without a troublesome processing.

A second exemplary embodiment of the present invention differs from the above-described first exemplary embodiment in the following points. Descriptions of the configuration and the other components of the multifunction peripheral of the present exemplary embodiment will be omitted since those are similar to the corresponding ones of the first exemplary embodiment (FIG. 1), respectively. Further, processes similar to those of the first exemplary embodiment (illustrated in FIG. 2) are used in storing the device information file.

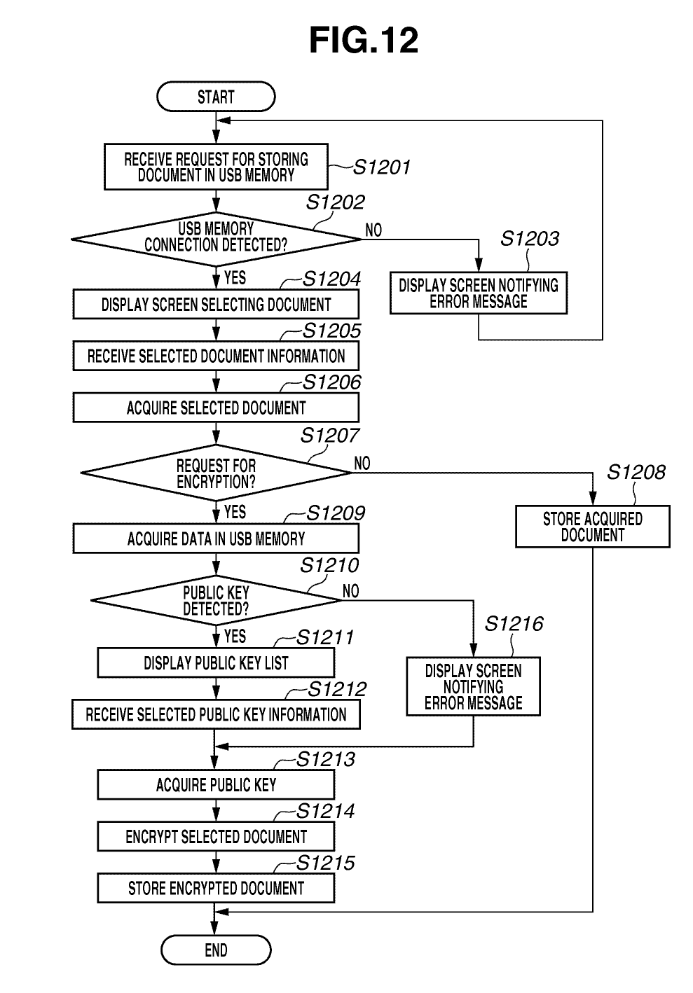

FIG. 12 is a flow chart illustrating an example of a process for storing the encrypted data in the portable storage medium in the multifunction peripheral.

In FIG. 12, descriptions of steps S1201 through S1207 are omitted since those are similar to the steps S901 through S907 illustrated in FIG. 9, respectively. If the CPU 101 determines that there is no encryption request in step S1207 (NO in step S1207), then in step S1208, the CPU 101 of the multifunction peripheral stores the document acquired in step S1206 in the USB memory and ends the present processing. On the other hand, if the CPU 101 determines that there is an encryption request in step S1207 (YES in step S1207), then in step S1209, the CPU 101 acquires data in the USB memory. In step S1210, the CPU 101 determines whether a public key is stored in the USB memory.

If the CPU 101 determines there is no public key in the USB memory in step S1210 (NO in step S1210), then in step S1216, the CPU 101 displays an error message notifying screen (not illustrated) on the operation unit 126 to notify the operator that there is no public key and thereafter, ends the present processing. On the other hand, if the CPU 101 determines that the public key is stored in the USB memory in step S1210 (YES in step S1210), then in step S1211, the CPU 101 obtains the public key list containing public key information from the USB memory and displays the public key list on the operation unit 126.

In step S1212, the CPU 101 receives the public key information that the operator has selected from the public key list displayed on the operation unit 126 and in step S1213, acquires the public key corresponding to the public key information from the USB memory. Subsequently, in step S1214, the CPU 101 causes the encryption unit 121 to encrypt the document acquired in step S1206 by using the public key obtained in step S1213 and, in step S1214, generates an encrypted document. In step S1215, the CPU 101 stores the encrypted document generated in step S1214 in the USB memory and ends the present processing.

In the present exemplary embodiment, for example, by storing in the USB memory the public key of the multifunction peripheral for printing, an encrypted document capable of being decrypted only by the multifunction peripheral for printing can be stored easily, when a document is stored in the USB memory by using another multifunction peripheral. Accordingly, the user can carry the document with him while keeping the confidentiality thereof without a troublesome processing being required.

Incidentally, the present exemplary embodiment is also applicable to applications other than printing. For example, it is possible that a document stored in a multifunction peripheral, which cannot send a facsimile, is carried by using the USB memory to another multifunction peripheral, which can send a facsimile, to thereby send a facsimile.

As described above, according to the present exemplary embodiment, various effects can be obtained, for example, it is possible to acquire a public key easily from a multifunction peripheral from which a public key for encrypting a document is difficult to acquire and security can be established in a similar way as described in the above described first exemplary embodiment.

In the first and the second exemplary embodiments, the control for acquiring the public key in the multifunction peripheral has been described. However, the present invention is not limited to the multifunction peripheral. The present invention is also applicable to a control for acquiring a public key in an image processing apparatus (e.g., a printer) other than the multifunction peripheral.

In the first and the second exemplary embodiments, the USB memory is exemplified as the portable storage medium. However, the present invention is not limited to the USB memory. The present invention is also applicable to any portable storage medium other than the USB memory.

In the first and the second exemplary embodiments, a digital certificate may be attached to a public key stored in USB memory. With the attached digital certificate, the public key improves in its authenticity.

Further, the object of the present invention is achieved by carrying out the following processing. That is, the object is achieved by such processing that a storage medium, which stores a program code of a software capable of realizing the functions of the above-described embodiments, is installed in a system or an apparatus, and a computer (for example, a CPU or a micro processing unit (MPU)) of the system or the apparatus reads out the program code stored in the storage medium.

In this case, the program code itself read out from the storage medium realizes the functions of the above-described exemplary embodiments and therefore, the program code and the storage medium storing the program code constitute the present invention.

The following can be used as the storage medium for supplying the program code. Examples include a floppy (registered trademark) disk, a hard disk, a magnet-optical disk, a compact disk read only memory (CD-ROM), a CD-recordable (CD-R), a CD rewritable (CD-RW), a digital versatile disk read only memory (DVD-ROM), a DVD random access memory (DVD-RAM), a DVD-RW, DVD+RW, an electromagnetic tape, a nonvolatile memory card, ROM. Alternatively, the program code may be downloaded through a network.

Further, such a case will be encompassed within a scope of the present invention that the functions of the above-described embodiments are realized by executing the program code read out by the computer. Additionally, such a case will also be encompassed within the scope of the present invention that an operating system (OS), which is running on the computer or the like performs a part or all of the actual processing, based on instructions of the program code, resulting in realizing the functions of the above-described exemplary embodiments.

Further, a case where the functions of the above-described exemplary embodiments are realized by the following processing will also be encompassed within the scope of the present invention. That is, the case where the program code read out from the storage medium is written into a memory of a function expansion board installed in the computer or a function expansion unit connected to the computer is also encompassed within the scope of the present invention. Thereafter, the CPU or the like of the function expansion board or the function expansion unit performs a part or all of the actual processing based on the command of the program code.

According to the present invention, if the CPU detects that the portable storage medium is connected to the image processing apparatus, since the public key is stored in the portable storage medium, the public key can be acquired with ease also from the multifunction peripheral, from which it is difficult to acquire the public key for encrypting a document.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2008-124615 filed on May 12, 2008, which is hereby incorporated by reference herein in its entirety.

What is claimed is:

1. An image processing apparatus to which a portable storage medium can be electrically connected, the image processing apparatus comprising:
a generation unit configured to generate a pair of a public key and a private key;
a medium detection unit configured to detect that the portable storage medium is connected to the image processing apparatus;
a determination unit configured to determine whether the public key generated by the generation unit is stored in the portable storage medium detected by the medium detection unit; and
a storage unit configured to automatically store the public key generated by the generation unit in the portable storage medium if the determination unit determines that the public key generated by the generation unit is not stored in the portable storage medium,
wherein the public key stored in the portable storage medium is available by another image processing apparatus and the another image processing apparatus is capable of creating an encrypted image which is decryptable to the image processing apparatus when the portable storage medium is attached to the another image processing apparatus.

2. The image processing apparatus according to claim 1, further comprising an information generation unit configured to generate device information including information relating to the public key,
wherein the storage unit stores the device information generated by the information generation unit in the portable storage medium.

3. The image processing apparatus according to claim 1, further comprising:
a key detection unit configured to detect that a public key generated by another image processing apparatus is stored in the portable storage medium when the medium detection unit detects that the portable storage medium is connected to the image processing apparatus;
an acquisition unit configured to acquire the public key from the portable storage medium when the key detection unit detects that the public key generated by the other image processing apparatus is stored in the portable storage medium; and
a registration unit configured to register the public key acquired by the acquisition unit in a memory unit.

4. The image processing apparatus according to claim 3, further comprising an analysis unit configured to analyze the device information stored in the portable storage medium when the key detection unit detects that the device information is stored in the portable storage medium,
wherein the key detection unit detects if the device information including information relating to the public key of the external image processing apparatus is stored in the portable storage medium, and
wherein the registration unit registers the public key included in the device information in the memory unit based on the analysis result of the analysis unit.

5. The image processing apparatus according to claim 4, wherein the memory unit stores address information of the external image processing apparatus, and
wherein the registration unit registers the public key included in the device information corresponding to the external image processing apparatus so as to be associated with the address information corresponding to the external image processing apparatus stored in the memory unit.

6. The image processing apparatus according to claim 3, further comprising an encryption unit configured to encrypt data by using the public key registered in the memory unit when the data storage is required in the portable storage medium,
wherein the storage unit stores the data encrypted by the encryption unit in the portable storage medium.

7. The image processing apparatus according to claim 3, further comprising an information detection unit configured to detect whether information including the public key is stored in the portable storage medium when the medium detection unit detects that the portable storage medium is connected to the image processing apparatus and a document is required to be stored in the portable storage medium,
wherein the acquisition unit acquires the public key from the portable storage medium when the information detection unit detects that the information including the public key is stored in the portable storage medium, and
wherein the storage unit generates the encrypted data by encrypting the document with the public key acquired by the acquisition unit and stores the encrypted data in the portable storage medium.

8. A method for controlling an image processing apparatus, to which a portable storage medium can be electrically connected, the method comprising:
generating a pair of a public key and a private key;
detecting that the portable storage medium is connected to the image processing apparatus;
determining whether the generated public key is stored in the detected portable storage medium; and
storing the generated public key in the portable storage medium automatically based on the determination that the generated public key is not stored in the detected portable storage medium,
wherein the public key stored in the portable storage medium is available by another image processing apparatus and the another image processing apparatus is capable of creating an encrypted image which is decryptable to the image processing apparatus when the portable storage medium is attached to the another image processing apparatus.

9. A computer-readable storage medium for storing a control program that causes an image processing apparatus, to which a portable storage medium can be electrically connected, to execute a method for controlling the image processing apparatus, the method comprising:
generating a pair of a public key and a private key;
detecting that the portable storage medium is connected to the image processing apparatus;
determining whether the generated public key is stored in the detected portable storage medium; and
storing the generated public key in the portable storage medium automatically based on the determination that the generated public key is not stored in the detected portable storage medium,
wherein the public key stored in the portable storage medium is available by another image processing apparatus and the another image processing apparatus is capable of creating an encrypted image which is decryptable to the image processing apparatus when the portable storage medium is attached to the another image processing apparatus.
